(19) United States
(12) Patent Application Publication
(10) Pub. No.: US 2010/0065140 A1
(43) Pub. Date: Mar. 18, 2010

(54) PIGGABLE WYE

(76) Inventors: Jeremy Duncan Stuart Joynson, Monaco (MC); Jean-Charles Rinaldi, Nice (FR)

Correspondence Address: LEON D. ROSEN;FREILICH, HORNBAKER & ROSEN, Suite 1220, 10960 Wilshire Blvd., Los Angles, CA, 90024, US

(21) Appl. No.: 12/503,698

(22) Filed: Jul. 15, 2009

Related U.S. Application Data
(60) Provisional application No. 61/096,645, filed on Sep. 12, 2008.
(60) Provisional application No. 61/115,762, filed on Nov. 18, 2008.

(51) Int. Cl. F16K 11/02

(52) U.S. Cl. 137/625.44; 137/625

(57) ABSTRACT

Apparatus is described for diverting a pig (62) from one pipeline (42) to a selected one of two or more other pipelines (44, 46), which is of compact and lightweight construction. The apparatus includes a pipe arrangement that includes an inlet (32) and first and second divergent outlets (34, 36), with gaps (70, 72) in adjacent sides of the outlets; The apparatus also includes a selection sleeve (64) that is pivotable about the inlet axis (52) between first and second positions wherein it diverts a pig received through the inlet, into the first or second outlets, respectively, while blocking the gaps.

### CROSS-REFERENCE

Applicant claims priority from U.S. provisional patent application S.N. 61/096,645 filed 12 Sep. 2008 and U.S. provisional patent application S.N. 61/115,762 filed 18 Nov. 2008.

### BACKGROUND OF THE INVENTION

Pigs, which are rounded plugs of spherical or cylindrical shapes, are used in hydrocarbon-carrying pipes to clean and inspect pipelines (which includes flowlines and pipelines). Pigs with instrumentation (“intelligent pigs”) are used to operate devices lying along a pipeline. A pig diverter is desirable to enable a pig to pass along a selected one of a plurality of pipelines. US patent publication 2005/0236050 which describes such a diverter, includes a heavy pivotable module that directs a pig that enters along an inlet, into a selected one of two outlets, and that directs a pig moving along one of the outlets into the inlet. It would be desirable if a diverter were available that was of much smaller weight to reduce costs of manufacture and costs of handling and supporting. Such a diverter also preferably allows a system to direct fluid or a pig along a desired one of a larger number of pipelines.

### SUMMARY OF THE INVENTION

In accordance with one embodiment of the invention, a pipeline diverter is provided which is of minimal weight and size (while still being constructed of a given high strength material such as steel), which diverts a pig and/or fluid, from an inlet into a selected one of a plurality of outlets, and which also can be-used to divert a pig (and/or fluid) entering a known one of the outlets into the inlet. The diverter comprises a pipe arrangement that includes an inlet pipe section that forms the inlet and first and second divergent downstream pipe sections that form the outlets. The downstream pipe sections have gaps in their adjacent sides at locations close to the inlet pipe section. The diverter also includes a selection sleeve that is movable between first and second positions and that fills the gaps in each position. In a first sleeve position, a pipe part of the sleeve directs flow (including pig movement) from the inlet to the first outlet (or in reverse). The sleeve also has a blocker part that, in the first position, blocks flow between the inlet and the second outlet.

In the second position of the selection sleeve, the pipe part of the sleeve directs flow from the inlet to the second outlet (or in reverse) while the blocker part blocks flow from the inlet to the first outlet.

The flow part of the selection sleeve has a portion curved about an axis of curvature to direct flow between pipe sections that are angled from each other. In one diverter, the passage formed by the flow part of the selection sleeve, has a bulge on a side opposite the axis of curvature of the flow part. The bulge allows an elongated pig to more easily move along a curved path between the inlet and one of the outlets.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a sectional view of a diverter of the prior art.

FIG. 2 is a sectional view of a diverter of the present invention, with the selection sleeve in a first position.

FIG. 3 is a sectional view similar to FIG. 2, but with the selection sleeve in a second position.

FIG. 4 is an isometric view of the selection sleeve of the diverter of FIG. 2.

FIG. 5 is a sectional view of a diverter of another embodiment of the invention, wherein the pipe part of the selection sleeve has a bulge in one side.

FIG. 6 is a sectional front view of a diverter of another embodiment of the invention wherein flow can be diverted into more than two paths, taken along line 6-6 of FIG. 7.

FIG. 7 is a sectional top view of the diverter of FIG. 6.

### DESCRIPTION OF THE PREFERRED EMBODIMENTS

FIG. 1 shows a diverter of the prior art, similar to what is shown in US patent publication 2005/0236050. The diverter includes a pivotable member 12 that has an inlet pipe section or inlet 14 and two outlet pipe sections or outlets 16, 18, that are each connectable to a separate pipeline. In the position of the pivotable member that is shown, a pig 20 entering the inlet 14 exits the outlet 18. The member 12 can be pivoted by 180° about an axis 22 by an actuator connected to a drive ring 24 (gear, pulley, etc.) so a pig entering the inlet 14 exits the second outlet 16. A common pipeline inside diameter for pipes used in hydrocarbon production and transfer, is sixteen inches. A pivotable member 12 for a pipeline of such diameter would have a large weight, which would result in high costs for manufacture, handling and support.

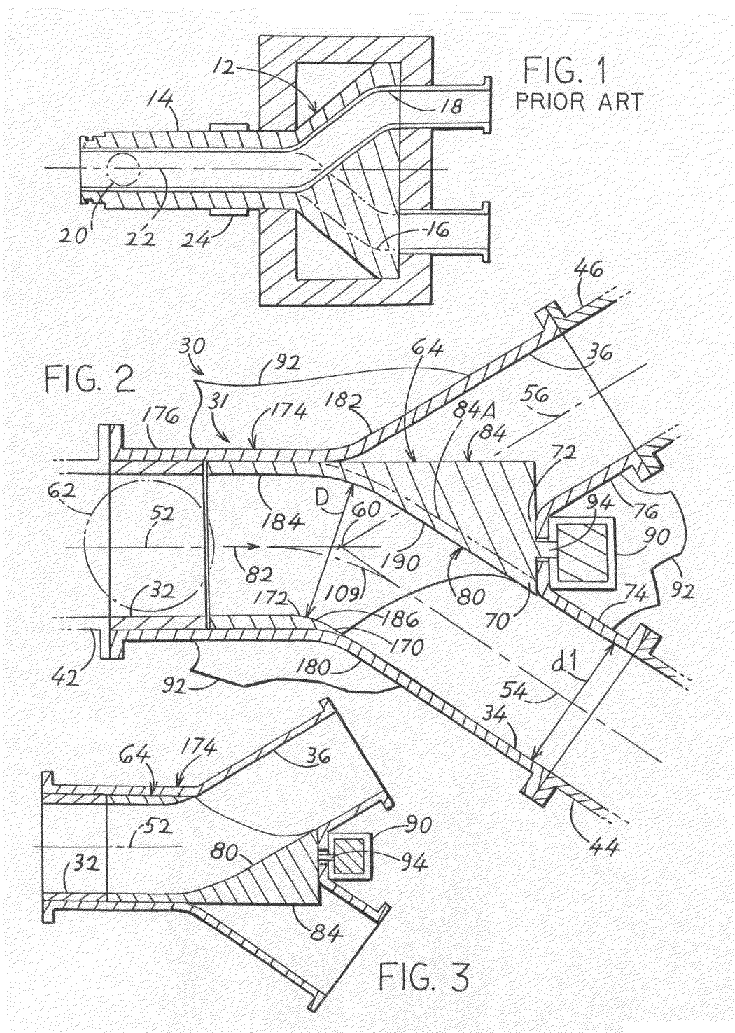

FIG. 2 shows a diverter 30 of the present invention, which comprises a stationary pipe arrangement 31 that includes an inlet upstream pipe section or inlet 32 (or “inlet passage”) and two outlet downstream pipe sections or outlets 34, 36 (or “outlet passages”), each of which is connected to a pipeline 42, 44, 46. The pipe sections have axes 52, 54, 56 that converge at point 60 which lies approximately on the inlet axis. The axes 54, 56 of the outlets diverge from each other at an angle of about 60° (between 40° and 80°). A pig 62 may be sent through the inlet pipeline 42 and directed into a selected one of the two outlet pipelines 44, 46 by moving a selection sleeve 64 to a selected one of two positions. The pig is pushed along the pipeline by pressured fluid (liquid or gaseous) behind it. Pigs are commonly in the form of a ball, or of a bullet. The outlet pipe sections 34, 36 have gaps 70, 72 in them in the region where they merge, the gaps lying in adjacent sides 74, 76 of the outlet pipe sections. The selection sleeve is shown in FIG. 2, in a first position, wherein a diverter pipe part 80 of the sleeve fills the gap 70 in the first outlet pipe section. The pipe part 80 also directs fluid (and a pig) moving along downstream arrow 82 in the inlet, into the first outlet pipe section 34, in a smooth transition between them so the path has a substantially constant diameter. A smooth transition is a transition between angled paths where the inside path diameter D perpendicular to the pipe walls does not decrease by more than 5% below the average (median) inside diameter d1, so a pig of round cross-section can pass through the diverter and will be constantly pushed by pressured fluid. The selection sleeve also has a blocker side or part 84 that blocks flow between the inlet 32 and second outlet 36. The blocker part 84 of the illustrated selector sleeve has a large thickness for rigidity and to facilitate its pivotal mounting. 16 The blocker part could have the outline shown at 84A, wherein the blocker part is formed by the outside of a pipe section whose inside forms the diverter pipe part 80, although that shape is not preferred.

FIG. 3 shows the diverter in the second position, wherein the selection sleeve 64 has been rotated 180° about the inlet axis 52 with part of the selection sleeve rotating within stationary tube 174. The diverter pipe part 80 then diverts a pig initially moving along the inlet 32 into the second outlet 36. At the same time, the blocker part 84 blocks flow into the first outlet 34.

The selection sleeve is pivoted, or rotated, between its two positions by an actuator 90 that is mounted on a housing 92 that is fixed with respect to the inlet and outlet pipe sections 32, 34, 36. A shaft 94 that is fixed to a rotating part of the actuator and to the sleeve, is turned to turn the selector sleeve. Pivoting by an angle such as 180° is preferably in opposite directions. The actuator can be electrically, hydraulically, or otherwise energized.

The above describes pigs moving into the diverter from the inlet 32. The diverter 30 also can be used to direct pigs moving into the diverter through a selected one of the two outlets and then to the inlet, so the pig exits the diverter through the inlet pipeline 42. However, for clarity in the description, applicant has described flow in a “downstream” direction 82.

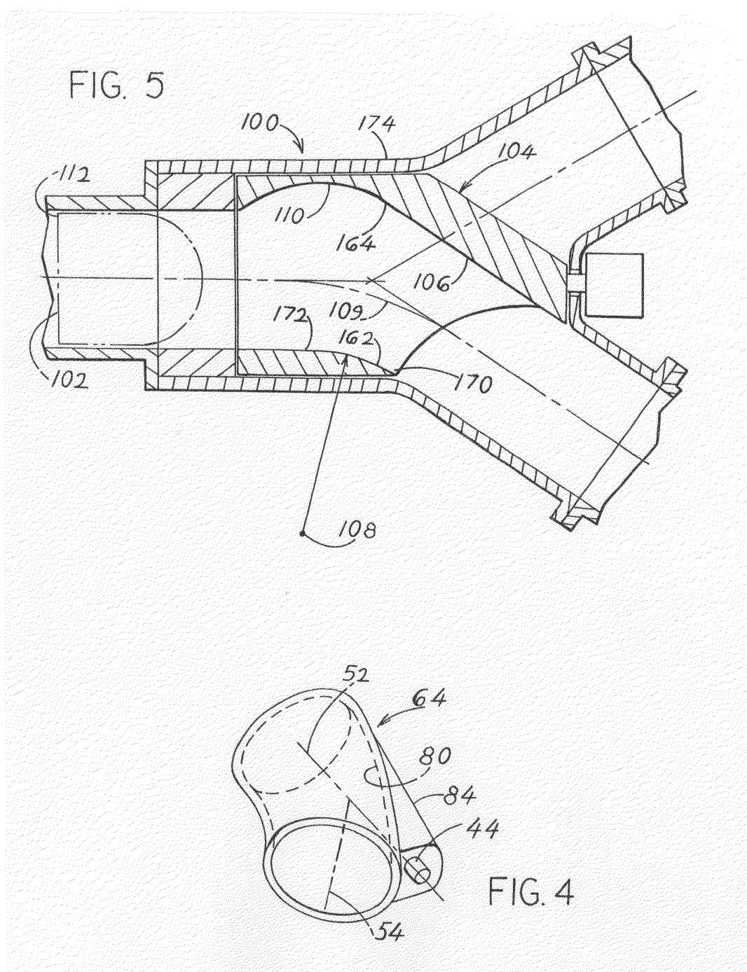

FIG. 5 shows a diverter 100 that is especially useful to divert a pig 102 that is of a bullet shape, or that is otherwise elongated. The pig is generally of the same diameter as the inside of the pipes that it is to pass through, with only a small clearance. For example, where the pipeline has an inside diameter of 16.0 inches, the pig may have an outside diameter of 15.9 inches. The diverter has a selection sleeve 104 wherein the diverter pipe part 106 has a center line 109 that is generally curved about a center of curvature 108. The pipe part has an outward bulge 110 on the side of the curved pipe centerline 109 that is opposite the center of curvature 108. The bulge 110 can receive a rear corner 112 of the pig as the pig moves around the curved pipe.

The pipe arrangement 31 of FIG. 2 includes a stationary tube 174 with a cylindrical upstream portion 176 whose inside is centered on the inlet axis 52 and with downstream portions 180, 182 that are angled to form portions of the outlets 34, 36. The pipe part 80 of the selection sleeve has an upstream portion 184 that lies closely within the cylindrical tube portion 176. The upstream portion 184 of the sleeve pipe part 80 is cylindrical except for a short slightly curved downstream end at 186. The pipe part 80 has a downstream portion 190 that lies on only one side of the flow centerline 109.

The pipe part 80 has a side with a thick end at 186 where it has a thickness at least 50% greater than that of the inlet and outlet pipelines 42, 44, 46 and of the tube 174. The extra thickness at 186 forms a curve between points 170, 172 that are spaced apart by no more than half said diameter D and that respectively face radially at the axis 54 and the axis 52.

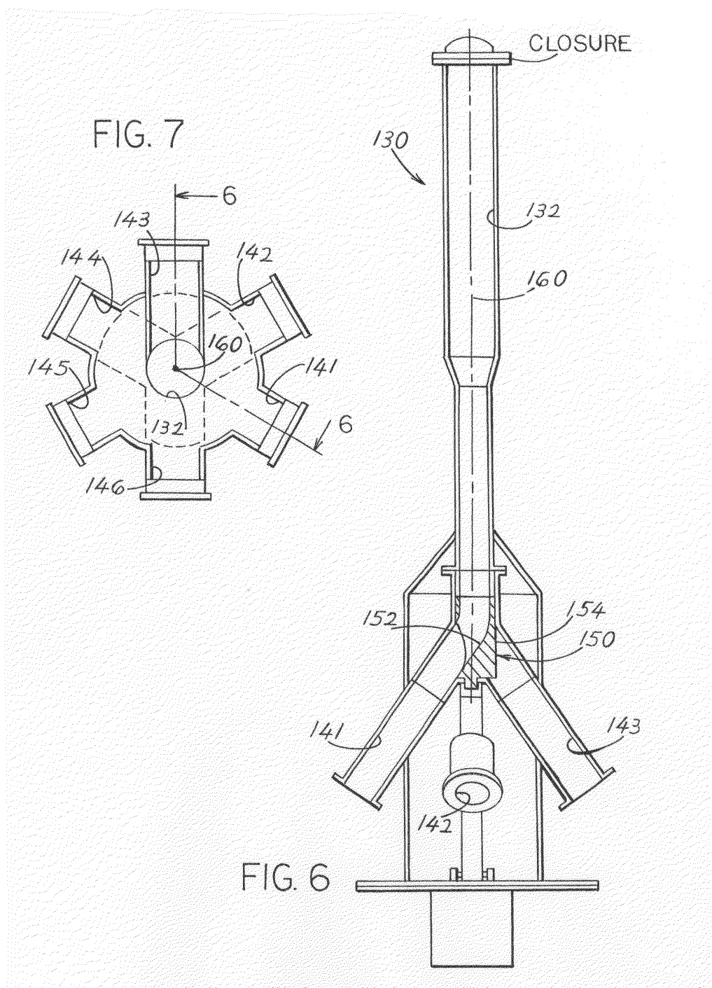

FIGS. 6 and 7 show a diverter in the form of a pig launcher 130 that has a common inlet pipe section, or inlet 132 and that can direct a pig that is placed in the inlet, into a selected one of six outlets pipe sections or outlets 141, 142, 143, 144, 145, 146. The outlets have axes spaced 60° apart when viewed along the inlet axis 160. The diverter has a selection sleeve 150 that rotates in 60° steps about axis 160. The selection sleeve is similar to that of FIG. 2, with a diverter pipe part 152 that smoothly directs flow from the inlet to a selected outlet. However, the selector sleeve is different because it has a blocker part 154 that blocks five of the six outlets when its diverter pipe part 152 directs flow from the inlet to the sixth one of the outlets. The diverter therefore can divert a pig moving along the inlet 132, into at least three different outlets (actually six of them), while blocking the others.

Thus, the invention provides a pipeline diverter for flow, especially of a pig, along a selected one of a plurality of paths that are selected by moving a selector sleeve to a selected one of a plurality of positions, usually by rotating the sleeve. The selector sleeve has a diverter pipe part that creates a smooth flow path of constant diameter between a common path and the selected path whose axes are angled apart by a plurality of degrees (usually at least 20°). The selector sleeve also has a blocker part that blocks flow through the other one or more paths that were not selected.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A pipeline diverter that has an inlet (32) with an inlet axis (52), that connects to an inlet pipe (42), comprising:
a pipe arrangement (31) that includes said inlet (32), and that includes at least first and second outlets (34, 36) with axes, said outlet axes each diverging by a plurality of degrees from said inlet axis and from each other, said outlets having upstream end portions with gaps (70, 72) in adjacent sides that are closest to said inlet axis;
a selection sleeve (64) that is moveable between at least first and second sleeve positions, said selection sleeve having a pipe part 80 that directs flow between said inlet (32) and first outlet (34) and said selection sleeve having a blocker part (84) that blocks flow between said inlet and said second outlet (36), in said first sleeve position;
said pipe part of said selection sleeve directs flow between said inlet and second outlet and said blocker part blocks flow between said inlet and said first outlet, in said second sleeve position.

2. The diverter described in claim 1 including:
an actuator (90) having a shaft (94) connected to said selection sleeve to turn it about said inlet axis between said first and second positions, said actuator located between said adjacent sides of said downstream pipe sections.

3. The diverter described in claim 1 wherein:
said pipe portion of said selection sleeve is curved about an axis of curvature (108), and said pipe portion of said selection sleeve has an outward bulge (110) on one of its sides that lies opposite said axis of curvature.

4. The diverter described in claim 1 wherein:
in said first sleeve position said selection sleeve pipe part (80) forms a smooth transition between said inlet pipe section and an inner side of said first inlet.

5. The diverter described in claim 1 wherein:
said pipe arrangement includes a third outlet (143) with an axis that intersects said inlet (132) and that diverges from said inlet and from said first and second outlets (141, 142), said third outlet having a gap in a side thereof;
said selection sleeve is moveable to a third sleeve position wherein said sleeve pipe part directs flow between said inlet and third outlet and fills the gap in said third outlet and said blocker part blocks flow through said first and second outlets.

6. The diverter described in claim 1 wherein said outlets lie in a generally downstream direction (82) from said inlet, and wherein:
said selection sleeve is rotatable about said inlet axis;
said pipe arrangement includes a stationary tube (174) with a cylindrical upstream portion (176) and with downstream portions (180, 182) that merge with sides of said first and second outlets (34, 36), said pipe part (80) of said selection sleeve has a cylindrical upstream portion (184) that is rotatable within said stationary tube cylindrical portion (176) about said inlet axis, and said pipe part has a curved downstream portion (190) that moves from a position to form part of said first outlet (34) to a position to form part of said second outlet (36), as said selection sleeve turns about said inlet axis.

7. A pipeline diverter comprising:
a pipe arrangement that includes a first pipe section (32) that has a first axis (52) and second and third pipe sections (34, 36) that have second and third axes (54, 56) that diverge in different directions from each other and from said first axis;
a selection sleeve (64) that is pivotable about said first axis between first and second positions;
said second and third pipe sections have adjacent sides with gaps (70, 72) in said adjacent sides;
said selection sleeve covers the gap in said third pipe section, blocks flow between said first and third pipe sections and directs fluid between said first and second pipe sections, in said first position of said selection sleeve;
said selection sleeve covers the gap in said second pipe section, blocks flow between said first and second pipe sections, and directs flow between said first and third pipe sections, in said second position of said selection sleeve.

8. The diverter described in claim 1 wherein:
said pipe arrangement includes a fourth pipe section (143) that has a fourth axis that diverges from said first, second and third axes;
said selection sleeve is pivotal about said first axis to a third position;
said fourth pipe section has a adjacent side that is adjacent to said second pipe section and that has a gap;
said selection sleeve covers the gap in said fourth pipe section and directs fluid between said first and fourth pipe sections, while blocking flow between said first pipe section and said second and third pipe sections, in said third position of said selection sleeve.

9. A pipeline diverter which has inlet and outlet ends, said diverter having an inlet pipe section (32) with an inlet pipe axis (52), said inlet pipe section lying at said diverter inlet end, and said diverter having at least first and second diverging outlet pipe sections (34, 36) having diverging outlet axes (54, 56) that lie at said diverter outlet end, comprising:
a selection sleeve (64) that has series-connected first and second sleeve parts (184, 190) with axes angled from each other, said first sleeve part lying within said diverter inlet pipe section, and said second sleeve part lying within said diverter outlet end, said sleeve being rotatable about said inlet pipe axis (52) between at least first and second positions wherein in said first position said second sleeve part is aligned with only a first of said outlet pipe sections, and in said second position said second sleeve part is aligned with only a second of said outlet pipe sections.

10. The diverter described in claim 9 wherein:
said selection sleeve has a pair of locations (170, 172) at one side of an outlet end of said sleeve, which respectively face radially to said inlet pipe axis (52) and to an axis (54) of said sleeve second part, said locations spaced apart by no more than one-half the diameter (D) of an inside of said sleeve.
